(19) United States
(12) Patent Application Publication
(10) Pub. No.: US 2003/0112804 A1
(43) Pub. Date: Jun. 19, 2003

(54) Method, system and architecture for service broadcasting over orthogonal frequency division multiplexing using an internet protocol cellular network & session initiated protocol

(76) Inventors: Jouni Kamarainen, Turku Verkapiha (FI); Matti Lipsanen, Rauhankatu (FI)

Correspondence Address: MORGAN & FINNEGAN, L.L.P., 345 Park Avenue, New York, NY, 10154-0053, US

(21) Appl. No.: 10/024,731

(22) Filed: Dec. 19, 2001

(51) Int. Cl. H04J 11/00

(52) U.S. Cl. 370/390; 370/338

(57) ABSTRACT

A method of providing broadcast service to a plurality of users, comprising hosting a first user and a second user, transmitting broadcast service to the first user, receiving a broadcast request from the second user, the broadcast request is for the broadcast service being transmitted to the first user, and transmitting the broadcast service to the second user. The second user receives a notification request from the first user which comprises information regarding the broadcast service being transmitted to the first user and identification information of the second user for notifying the second user regarding the broadcast service being transmitted to the first user. The two users are allowed voice communication therebetween, wherein the voice communication is conducted simultaneous to the transmission of broadcast service to the second user.

### FIELD

A method, system and architecture for obtaining broadcast services over a wireless network, and more particularly to a method, system and architecture for obtaining and sharing broadcast services with other users over a wireless network.

### BACKGROUND

Networks

Networks are commonly thought to consist of the interconnection and interoperation of clients, servers, and intermediary nodes in a graph topology. It should be noted that the term “server” as used herein refers generally to a computer, other device, software, or combination thereof that processes and responds to the requests of remote users across a communications network. Servers serve their information to requesting “clients.” A computer, other device, software, or combination thereof that facilitates, processes information and requests, and/or furthers the passage of information from a source user to a destination user is commonly referred to as a “node.” Networks are generally thought to facilitate the transfer of information from source points to destinations. There are many forms of networks such as Local Area Networks (LANs), Wide Area Networks (WANs), Pico networks, etc.

Internet

The Internet is a network of networks. It is an interconnection of various and disparate networks that are disposed in communication with one another. This interconnectivity and intercommunications provided by the Internet is in large part facilitated through the use of common transmission protocols. As Internet usage increases, the amount of information and/or services available on the Internet also increases. This makes the Internet a valuable information transportation vehicle.

Digital Video Broadcasting-Terrestrial

Digital Video Broadcasting-Terrestrial networks (DVB-T) is a digital TV system for terrestrial broadcasting developed for the stationary and portable reception of broadcast and data services. DVB-T networks can offer bitrates up to 32 Mbits/s and in mobile environments up to 15 Mbits/s. DVB-T network application has been seen to be invaluable in the area of mobile reception of video, file downloading, Internet and multimedia data as these services can be offered more cost effectively as compared to cellular networks.

For the best adaptation to some local constraints of digital TV broadcasting, DVB-T system relies on Orthogonal Frequency Division Multiplexing (OFDM) modulation (2K carriers or 8K carriers) and includes many different variants for the coding modes. DVB-T lends itself as being superior to current analog TV technology because it does not suffer from multi-path and fading problems. In addition, when installed in a moving vehicle a DVB-T receiver provides clear pictures and good music quality. Further, since DVB-T technology is digital, multiplex transmission of maps and other navigation information is possible as a supplementary data service offered in parallel with the video/audio broadcast.

Session Initiation Protocol

The Session Initiation Protocol (SIP) is an Internet Engineering Task Force (IETF) standard protocol for initiating an interface user session that involves multimedia elements. Each session may include different types of data such as audio and video. This protocol is an open standard and is scalable and has been designed to be a general purpose protocol. A merit of using SIP lies in its location-independent address system feature which enables the capability to reach a called party based on the party's name and redirection parameters. This also allows networks to identify the users wherever they are. SIP is a request-response protocol, dealing with requests from clients and responses from servers. Users or participants are identified by SIP Uniform Resource Locators (URLs). Users function as clients when initiating requests and as servers when responding to requests. Requests can be sent through any transport protocol, such as User Datagram Protocol (UDP), Stream Control Transmission Protocol (SCTP), or Transmission Control Protocol (TCP). Users may communicate directly with each other or via an intermediate server. SIP determines the end system to be used for the session, the communication media and media parameters and the called party's desire to engage in the communication. Once these factors are assured, the SIP establishes call parameters at either end of the communication and handles call transfer and termination.

Home Location Register/Visiting Location Register

The Home Location Register (HLR) is the main database of permanent subscriber information for a mobile network holding pertinent user information, including address, account status, and preferences. The HLR interacts with the Mobile Switching Center (MSC), which is a switch used for call control and processing. The MSC also serves as a point-of-access to the Public Switched Telephone Network (PSTN—the fixed network). Similar to the HLR is the Visiting Location Register (VLR), which maintains temporary user information (such as the user's current location) to manage requests from subscribers who are out of the area covered by their home system. When a user initiates a call, the switching equipment determines whether or not the call is coming from the device's home area. If the user is out of the home area, the area VLR sends out a request for information required to process the call. An MSC queries the HLR identified by the call for information, which it relays to the appropriate MSC, which in turn relays it to the VLR. The VLR sends routing information back to the MSC which allows it to find the station where the call originated, and, finally, the mobile device to connect.

Third Generation (3G) Wireless Networks

3G Wireless network is a global development of communication standards and technologies which will ultimately lead to users being able to access multimedia services with mobile terminals. 3G systems enable multimedia application due to the application of high-speed data transfer and advanced radio terminal technology.

As is well known, the 3G overcomes the technical shortcomings of the first and the second generations, and allows easy and efficient deployment (i.e., widespread deployment at economical costs). The chief requirements for 3G technology are that the voice quality must be comparable to that of the public switched telephone network, data rate must be 144 kb/s for users in motor vehicles moving fast over large areas and must be 384 kb/s for those moving slowly over small areas, there must be support for 2.048-Mb/s operation for office use, packet-switched as well as circuit-switched data services must be supported, and there must be more efficient usage of the available spectrum among other requirements.

Some of the chief 3G technologies are W-CDMA, cdma2000, UMTS, GPRS, EDGE and UWC-136. 3G brings together high-speed radio access and Internet Protocol (IP)-based services into one environment. The step towards IP is vital. IP is packet-based, which in simple terms, means users can be “on line” at all times, but without having to pay until we actually send or receive data. The connectionless nature of IP also makes access a lot faster: file downloads can take a few seconds and we can be connected to our corporate network with a single click. 3G introduces wideband radio communications, with access speeds of up to 2 Mbit/s. Compared with today's mobile networks, 3G will significantly boost network capacity so operators will be able to support more users, as well as offer more sophisticated services

Using 3G wireless, users have global access to a variety of voice, data and video services. Users are able to access their communications services easily from anywhere using any terminal. The distinctions between wireline, wireless and data services are blurring. Users simply choose the most convenient means to communicate, while network operators choose the most efficient way to transport communications, thus saving money for both the user as well as the service provider.

With 3G wireless, subscribers have data access speeds that are more than 20 times faster than other conventional means of communicating. 3G not only offers multimedia capabilities, but also location-enabled features such as 911. Thus, a user from Tokyo may use his phone in New York to dial 911, and New York emergency crews can pinpoint his location to send help. 3G technology also allows subscribers to access several services at once. For example, a user can carry on a voice conversation while surfing the Internet, or participate in a video conference while sending a fax. What's more, the third generation offers a true global wireless system, permitting users to roam all over the world and make connections with anyone, anywhere.

While 3G is generally considered applicable mainly to mobile wireless, it is also relevant to fixed wireless and portable wireless. The ultimate 3G system might be operational from any location on, or over, the earth's surface, including use in or by homes, businesses, government offices, medical establishments, the military, personal and commercial land vehicles, private and commercial watercraft and marine craft, private and commercial aircraft (except where passenger use restrictions apply), portable (pedestrians, hikers, cyclists, campers), space stations and spacecraft, and many others. Proponents of 3G technology promise that it will “keep people connected at all times and in all places.”

Unfortunately, despite the progresses being made, it remains difficult to get broadcast services pointed and shared between a plurality of different end users. Further, sharing of same broadcast IP data content between various users remains elusive.

### SUMMARY

The present invention relates to a method, system and architecture for obtaining and sharing broadcast services with other users over a wireless network. The architecture integrates a number of components, networks and protocols for allowing one or more users to obtain and share broadcast services with other users over a wireless network. In addition to sharing multimedia content, simultaneous connection of several services to a terminal is possible. Further, sharing of same broadcast IP data content with another user can be done easily. Further yet, SIP and service carousel features are used in an all-IP network to get broadcast services pointed and shared with other end users.

To accomplish its goals, the present invention enables the connection of broadcast services over DVB-T to cellular network services.

One embodiment of the invention is a method of providing broadcast service to a plurality of users, comprising hosting a first user and a second user, transmitting broadcast service to the first user, receiving a broadcast request from the second user, and transmitting the broadcast service to the second user. The two users are allowed voice communication therebetween, wherein the voice communication is conducted simultaneous to the transmission of broadcast service to the second user.

### BRIEF DESCRIPTION OF THE FIGURES

FIG. 1 depicts the architecture of the disclosed system for sharing of broadcast services between a plurality of users over a wireless network.

FIG. 2 is a flow diagram for the method of sharing of broadcast services between a plurality of users over a wireless network.

### DETAILED DESCRIPTION OF THE FIGURES

The present invention allows obtaining and sharing of broadcast services between a plurality of users over a wireless network. In addition to sharing broadcast data, simultaneous connection of several services to a terminal is possible. Further, sharing of same broadcast IP data content with another user can be done seamlessly. The SIP and service carousel features are used in an all-IP network to get broadcast services pointed and shared with other end users.

To accomplish its goals, the present invention enables the connection of broadcast services over DVB-T to cellular network services.

With reference to the Figures, various embodiments of the method, system and architecture for obtaining and sharing broadcast services with other users over a wireless network will now be described in greater detail. It is to be understood that the tasks shown in the Figures and described in this Detailed Description can be sequenced in many different orders to achieve the desired result. The order or sequence of tasks illustrated in the Figures is merely intended to be exemplary of the concepts defined herein.

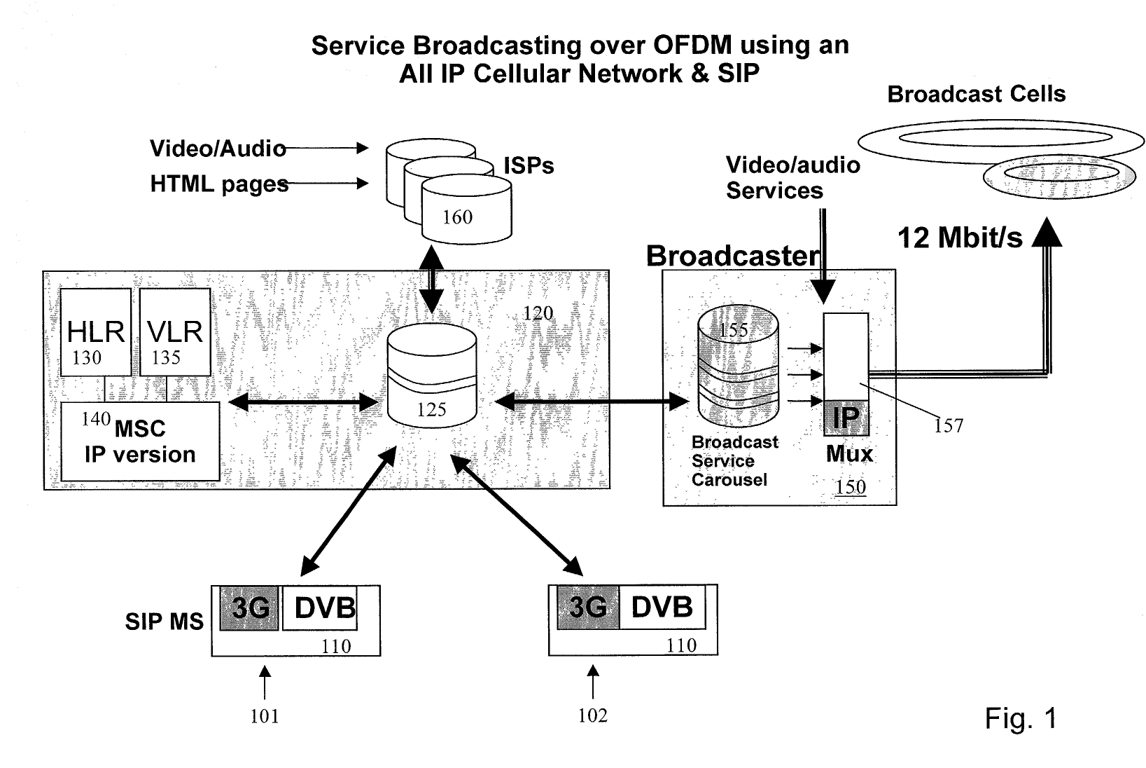

FIG. 1 depicts one embodiment of the architecture for obtaining and sharing broadcast services/data with other users over a wireless network.

A first user 101 and a second user 102 each communicate therebetween using wireless devices 110. The wireless terminals 110 have a terminal, which displays and allows access to information and broadcast services/data thereon. The wireless devices 110 receive their wireless data as well as broadcast services/data from a telecommunication service provider 120. The wireless devices are equipped to handle 3G services as well as DVB-T signals.

The telecommunication service provider 120 comprises an SIP Server 125. The SIP Server receives and transmits data using SIP. As noted above, SIP is a signaling protocol for Internet conferencing, telephony, presence, events notification and instant messaging. SIP is a tradition text-based Internet protocol, which resembles hypertext transfer protocol (HTTP) and simple mail transfer protocol (SMTP). While SIP is an open standard and is scalable, it has been designed to be a general-purpose protocol.

The basic structure of SIP is client/server in nature. According to one of the embodiments, the main entities in SIP are a user agent and a SIP server 125. The SIP server 125 comprises a SIP proxy server, SIP redirect server and SIP registrar. The user agents, or SIP endpoints, function as clients (such as end users 101 and 102) when initiating requests and as servers when responding to requests user agents communicate with other user agents directly or via an intermediate server.

SIP intermediate servers have the capability to behave as proxy or redirect servers SIP proxy servers forward requests from the user agent to the next SIP server 125, user agent within the network and may also retain information for billing/accounting purposes SIP redirect servers respond to user requests and inform them of the requested server's address.

The third entity that comprises SIP architecture is the SIP registrar. The user agent sends a registration message to the SIP registrar and the registrar stores the registration information in a location service via a non-SIP protocol. Once the information is stored, the Registrar sends the appropriate response back to the user agent.

In addition, the telecommunication service provider 120 comprises a Home Location Register (HLR) 130, a Visitor Location Register (VLR) 135 and a Mobile Switch Center (MSC) 140, all of which communicate with the SIP server 125. In one embodiment, the HLR 130 is the main database of permanent subscriber information for the mobile network. The HLR 130 may hold pertinent user information, including address, account status, and user preferences. The HLR 130 interacts with the MSC 140, which is a switch used for call control and processing. The MSC 140 may also serve as a point-of-access to the Public Switched Telephone Network (PSTN—the fixed network). Similar to the HLR 130 is the VLR 135, which maintains temporary user information (such as the user's current location) to manage requests from subscribers who are out of the area covered by their home system. When a user initiates a call, the switching equipment determines whether or not the call is coming from the device's home area. If the user is out of the home area, the area VLR 135 may send out a request for information required to process the call. The MSC 140 queries the HLR 130 identified by the call for information, which it relays to the appropriate MSC 140, which in turn relays it to the VLR 135. The VLR 135 sends routing information back to the MSC 140 which allows it to find the station where the call originated, and, finally, the mobile device to connect. As noted above, all transmission of data (voice and/or broadcast) from the telecommunication service provider 120 is via the SIP server.

The telecommunication service provider 120 may be connected one or more broadcasters 140 that provide dynamic broadcast services/data thereto. In one embodiment, the broadcast services/data comprises audio and/or video services, and may be stored and transmitted in digital format. In turn, the telecommunication service provider 120 can forward the received broadcast services/data to one or more users that desire receipt thereof. The broadcaster 150 comprises a broadcast service carousel 155 and an Internet protocol multiplexer 157. The broadcaster 150 may also transmit its broadcast services/data to various broadcast cells.

The telecommunication service provider 120 may also receive data/service from one or more Internet service providers (ISPs) 160. The data/service may be in video/audio format or HTML format that is viewable and accessible on the wireless device 110.

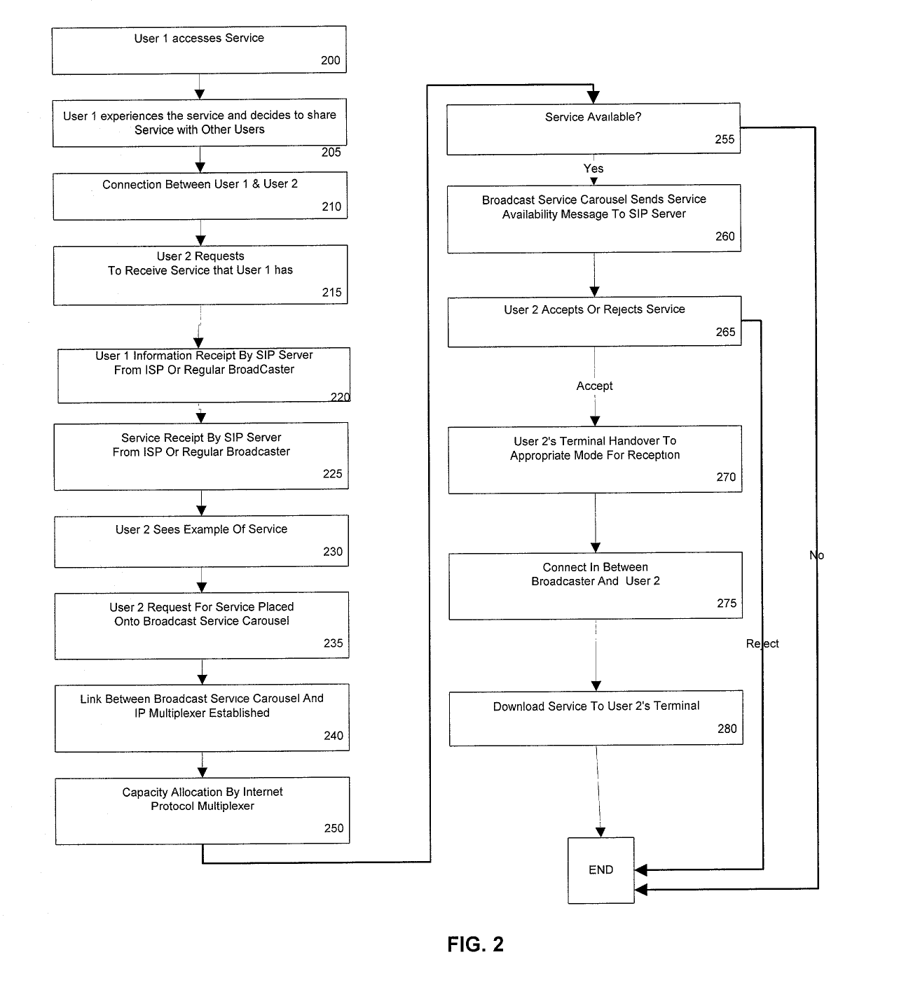

FIG. 2 is a flow diagram that depicts one embodiment of the method for obtaining and sharing broadcast services with other users over a wireless network.

In step 200, the first user 101 accesses a service from the telecommunication service provider 120. The accessed service may be obtained via broadcast services/data, which may be in video/audio format, HTML format, and/or the like. In step 205, the first user 101 experiences the accessed service and may decide to share the information regarding the accessed service with or more other subscribers of the telecommunication service provider 120. The shared information may include the location address for obtaining the accessed service.

In step 210, the first user 101 contacts a second user 102 and conveys information regarding the underlying service that the first user 101 is accessing/experiencing. In one embodiment, the contact is made using the wireless device 110. The wireless devices have terminals which have multi-mode capabilities, such as capabilities for SIP, 3G and DVB-T.

In step 215, the second user 102 requests the telecommunication service provider 120 to receive the broadcast services/data that the first user 101 is receiving. It should be noted that the second user 102 makes the request for the broadcast services/data using the wireless device 110, while simultaneously remaining in contact with the first user 101 and continuing to communicate therewith. The SIP Server 125 of the telecommunication service provider 120 receives the necessary information about the first user 101 or the second user 102 from either the HLR 130 or the VLR 135 in step 220.

The telecommunication service provider 120 receives the broadcast services/data from an external source in step 225 which is being requested/used by the first user 101. According to one embodiment, the broadcast services/data may be received from the ISP 160. According to another embodiment, the broadcast services/data may be received from the broadcaster 150. According to yet another embodiment, the broadcast services/data may be stored internally.

In step 230, the second user 102 is provided a sampling of the requested broadcast services/data. After seeing an example of the broadcast service, the second user places its request for the broadcast service, in step 235. The request is placed through the telecommunication service provider 120 which may further transmit the request to the appropriate source for the broadcast data/service, namely the ISP 160 or the broadcaster 150 or both.

If the request is forwarded to the broadcaster 150, then in step 240, a link between broadcast service carousel 155 and the IP multiplexer 157 is established. In step 250, based on the service requested by the second user 102, the IP multiplexer 157 allocates the appropriate capacity.

In step 255, the system checks to determine if the requested broadcast service is available. If the requested broadcast service is available, the broadcast service carousel 155 sends a service availability message to the SIP server 125 in step 260; otherwise, the system terminates the transmission session. Once the broadcast service carousel sends a service availability message to the SIP server 125 in step 260, the second User 102 has a choice of either accepting or rejecting the service in step 265.

If the second user 102 rejects the service, the transmission session is terminated. If, however, the second user 102 accepts receipt of the broadcast service, then the mobile device 110 conducts the handover procedure for switching to the appropriate mode for receipt of the broadcast service, in step 270. For example, if the desired service is a video clip, the mobile device 110 will switch from 3G mode to DVB-T.

Next, a connection is established between the broadcaster 150 and the second user 102 via the telecommunication service provider 120, in step 275. The requested service is then downloaded or sent to the second user 102, in step 280. Once the request broadcast service is complete or no longer desired by the second user, the transmission session terminates.

It should be noted that the original connection between the first user 101 and the second 102 continues to be maintained during the entire processed discusses above.

In summary, herein is described a method, system and architecture for transmitting broadcast services/data between a plurality of subscribers of a telecommunication service. While the broadcast services/data are experienced by the plurality of subscribers, these subscribers can continue to remain in connection via their original modes of connection.

Although illustrative embodiments have been described herein in detail, it should be noted and understood that the descriptions have been provided for purposes of illustration only and that other variations both in form and detail can be made thereupon without departing from the spirit and scope of this invention. The terms and expressions have been used as terms of description and not terms of limitation. There is no limitation to use the terms or expressions to exclude any equivalents of features shown and described or portions thereof and this invention shown be defined with the claims that follow.

1. A method of providing broadcast service to a plurality of users, comprising:
a. hosting a first user and a second user;
b. transmitting broadcast service to said first user;
c. receiving a broadcast request from said second user, said broadcast request for said broadcast service being transmitted to said first user; and
d. transmitting said broadcast service to said second user.

2. The method of claim 1, further comprising receiving a notification request from said first user after said transmitting of broadcast service to said first user, said notification request comprising:
a. information regarding said broadcast service being transmitted to said first user; and
b. identification information of said second user for notifying said second user regarding said broadcast service being transmitted to said first user.

3. The method of claim 2, further comprising notifying said second user regarding broadcast service being transmitted to said first user before said receiving of broadcast request from said second user.

4. The method of claim 3, wherein said broadcast service are transmitted to said second user via a session initiation protocol server.

5. The method of claim 4, further comprising providing voice communication between said first user and said second user, said voice communication being simultaneous with said transmission of broadcast service to said second user.

6. The method of claim 5, wherein said first user receives broadcast service on a first wireless device.

7. The method of claim 6, wherein said first user receives voice communication over said first wireless device.

8. The method of claim 7, wherein said second user receives broadcast service on a second wireless device.

9. The method of claim 8, wherein said second user receives voice communication over said second wireless device.

10. The method of claim 9, wherein said first wireless device and said second wireless device are configured to receive Digital Video Broadcasting-Terrestrial signals.

11. The method of claim 10, wherein said first wireless device and said second wireless device are configured to communicate using session initiation protocol.

12. The method of claim 9, wherein said broadcast services comprise audiovisual content.

13. The method of claim 9, further comprising receiving broadcast services from at least one broadcaster connected therewith.

14. The method of claim 13, further comprising receiving broadcast content from at least one Internet service provider connected therewith.

15. A method of obtaining broadcast service over a telecommunication network, the broadcast service accessible with a wireless device, comprising:
a. receiving a notification regarding the availability of the broadcast service from a first user of the telecommunication network;
b. requesting the broadcast service from a broadcast service provider; and
c. receiving requested broadcast service from said broadcast service provider,
wherein a simultaneous connection is maintained with said first user while obtaining the broadcast services, said simultaneous connection being used to transmit voice therebetween.

16. The method of claim 15, wherein said broadcast service is received via a telecommunication service provider.

17. The method of claim 16, wherein said notification comprises:
a. information regarding said broadcast service being transmitted to said first user; and
b. identification information of said second user for notifying said second user regarding said broadcast service being transmitted to said first user.

18. The method of claim 17, wherein said broadcast service and said voice information are received on a wireless device, said wireless device equipped to receive Digital Video Broadcasting-Terrestrial signals, said wireless device further configured for session initiation protocol.

19. The method of claim 18, further comprising receiving download information regarding the requested broadcast service from said broadcast service provider before said receiving of the requested broadcast service.

20. The method of claim 19, wherein said broadcast service is in audio-visual format.

21. A system of providing broadcast service to a plurality of users, comprising:
a. a memory unit; and
b. a processor in communication with said memory unit, said processor configured for:
hosting a first user and a second user,
transmitting broadcast service to said first user,
receiving a broadcast request from said second user, said broadcast request for said broadcast service being transmitted to said first user, and
transmitting said broadcast service to said second user.

22. The system of claim 21, wherein said processor is further configured for receiving a notification request from said first user after said transmitting of broadcast service to said first user, said notification request comprising:
a. information regarding said broadcast service being transmitted to said first user; and
b. identification information of said second user for notifying said second user regarding said broadcast service being transmitted to said first user.

23. The system of claim 22, wherein said processor is further configured for notifying said second user regarding broadcast service being transmitted to said first user before said receiving of broadcast request from said second user.

24. The system of claim 23, wherein said broadcast service are transmitted to said second user via a session initiation protocol server.

25. The system of claim 24, wherein said processor is farther configured for providing voice communication between said first user and said second user, said voice communication being simultaneous with said transmission of broadcast service to said second user.

26. The system of claim 25, wherein said first user receives broadcast service on a first wireless device.

27. The system of claim 26, wherein said first user receives voice communication over said first wireless device.

28. The system of claim 27, wherein said second user receives broadcast service on a second wireless device.

29. The system of claim 28, wherein said second user receives voice communication over said second wireless device.

30. The system of claim 29, wherein said first wireless device and said second wireless device are configured to receive Digital Video Broadcasting-Terrestrial signals.

31. The system of claim 30, wherein said first wireless device and said second wireless device are configured to communicate using session initiation protocol.

32. The system of claim 29, wherein said broadcast services comprise audiovisual content.

33. The system of claim 29, wherein said processor is further configured for receiving broadcast services from at least one broadcaster connected therewith.

34. The system of claim 33, wherein said processor is further configured for receiving broadcast content from at least one Internet service provider connected therewith.

35. A system of obtaining broadcast service over a telecommunication network, the broadcast service accessible with a wireless device, comprising:
a. a memory unit; and
b. a processor in communication with said memory unit, said processor configured for:
receiving a notification regarding the availability of the broadcast service from a first user of the telecommunication network,
requesting the broadcast service from a broadcast service provider, and
receiving requested broadcast service from said broadcast service provider,
wherein a simultaneous connection is maintained with said first user while obtaining the broadcast services, said simultaneous connection being used to transmit voice therebetween.

36. The system of claim 35, wherein said broadcast service is received via a telecommunication service provider.

37. The system of claim 36, wherein said notification comprises:
a. information regarding said broadcast service being transmitted to said first user; and
b. identification information of said second user for notifying said second user regarding said broadcast service being transmitted to said first user.

38. The system of claim 37, wherein said broadcast service and said voice information are received on a wireless device, said wireless device equipped to receive Digital Video Broadcasting-Terrestrial signals, said wireless device further configured for session initiation protocol.

39. The system of claim 38, wherein said processor is further configured for receiving download information regarding the requested broadcast service from said broadcast service provider before said receiving of the requested broadcast service.

40. The system of claim 39, wherein said broadcast service is in audio-visual format.

41. A wireless device for obtaining broadcast service, comprising:
a. means for communicating with a second communication device, said means for communicating being capable of supporting multimedia applications and having capability to engage in high-speed data transfer; and
b. means for receiving stationary and portable reception of broadcast and data services,
wherein said means for communicating and said means for receiving stationary and portable reception of broadcast and data services are operational concurrently.
